(19) United States
(12) Patent Application Publication
(10) Pub. No.: US 2020/0381151 A1
(43) Pub. Date: Dec. 3, 2020

(54) Integrally-Molded Inductor and Method for Manufacturing Same

(71) Applicant: Shenzhen Sunlord Electronics Co., Ltd., Shenzhen (CN)

(72) Inventors: Shengcheng XIA, Shenzhen (CN); Gengxin XIAO, Shenzhen (CN); Xinshu YU, Shenzhen (CN)

(21) Appl. No.: 16/999,042

(22) Filed: Aug. 20, 2020

Related U.S. Application Data
(63) Continuation of application No. PCT/CN2018/087736, filed on May 22, 2018.

(51) Int. Cl. H01F 1/153; H01F 17/04; H01F 41/26; H01F 41/22; H01F 41/02

(52) U.S. Cl. CPC H01F 1/15333; H01F 1/15383; H01F 1/15308; H01F 2017/048; H01F 41/26; H01F 41/22; H01F 41/0246; H01F 17/04

(57) ABSTRACT

An integrally-molded inductor comprises a coil having an insulation coating layer and a magnetic material integrally molded with the coil by compression molding, with electrodes, which are exposed outside the magnetic material, formed at two ends of the coil, wherein the insulation coating layer of the coil comprises a non-conductive inorganic particle component and a resin component which are uniformly mixed, the inorganic particle component and the resin component being in a ratio by weight percentage of 70%:30% to 90%:10%. According to the integrally-molded inductor and a method for manufacturing same, the pressure resistance of the integrally-molded inductor is improved, and the electrical properties and reliability of the inductor product are improved.

### CROSS REFERENCE TO RELATED APPLICATIONS

This application is a continuation application of PCT/CN2018/087736 filed on 2018 May 22. The contents of the above-mentioned application are all hereby incorporated by reference.

### BACKGROUND OF THE INVENTION

### 1. Field of the Invention

The present invention relates to an integrally-molded inductor and a method for manufacturing same.

### 2. Description of the Related Art

In recent years, with miniaturization and high-performance development of personal computers and electronic equipment, there is an urgent need for power supply circuits that supply power to their electronic circuits to be further miniaturized and thinned with ability to supply high current. Therefore, in order to meet the needs of the market, the manufacturing technology in the inductor industry becomes more advanced with improved practicability, and the integrally-molded inductor appears as a result of the development of the inductor technology. Compared with the traditional inductor, the integrally-molded inductor mainly has the following advantages in three aspects: (1) in material selection: low-loss alloy powder die-casting, low impedance, no lead terminals and low parasitic capacitance; (2) in structure features: firmness, accurate thickness and durability in rust prevention of the product; and (3) in practicability: small volume, high current, excellent temperature rise current and saturation current characteristics in high-frequency and high-temperature environments, and wide working frequency coverage.

However, the existing integrally-formed inductor also has technical shortcomings which cannot be ignored. The electrical properties of the conventional integrally-molded inductor are mainly determined by the magnetic material, and with the same material, the permeability and saturation magnetic flux are positively correlated with the density, and one way to increase the density is to increase the molding pressure. At present, an integrally-molded inductor product cannot bear a high pressure when subjected to compression molding, and the reason is that the self-bonding enameled copper wires used for the integrally-molded inductor are generally coated with an organic coating. However, the self-bonding copper wires with an organic coating may have a defect that if an inductor is manufactured by molding a blank with pressure, the organic coating outside of the copper wire may be broken under the external high pressure, posing a risk that the product may be short-circuited because of the exposure of the copper wires. In addition, as the pressure resistance of the organic coating is poor and thus the density of the molded product is low, the electrical properties of the product manufactured by using enameled copper wires with an organic coating are limited.

Therefore, there is a great need for an integrally-molded inductor which can be manufactured by compression molding under high pressure, thereby improving the reliability of an integrally-molded inductor.

### SUMMARY OF THE INVENTION

A main object of the present invention is to overcome the defects in the prior art, and provides an integrally-molded inductor and a method for manufacturing the same, whereby the pressure resistance of the integrally-molded inductor is improved, and the properties and reliability of the product are improved.

In order to achieve the above object, the present invention adopts the following technical scheme:

an integrally-molded inductor, comprising a coil having an insulation coating layer and a magnetic material integrally molded with the coil by compression molding, with electrodes, which are exposed outside the magnetic material, formed at two ends of the coil, wherein the insulation coating layer of the coil comprises a non-conductive inorganic particle component and a resin component which are uniformly mixed, the inorganic particle component and the resin component being in a ratio by weight percentage of 70%:30% to 90%:10%.

Further, the inorganic particle component comprises any one or more of SiO₂, Al₂O₃, and SiC.

Further, the resin component comprises any one or more of polyimide and polyurethane.

Further, magnetic material is iron-based metal alloy soft magnetic powder, and preferably, the soft magnetic powder is any one of carbonyl iron powder, FeSiCr, FeNi50, MPP, amorphous soft magnetic powder, and nanocrystalline soft magnetic powder, and most preferably, is FeSiCr.

Further, a material for forming the electrodes is silver paste.

Further, the insulation coating layer of the coil is further coated with a self-bonding layer.

A method for preparing the integrally-molded inductor comprises following steps of:

S1, preparing a coil having an insulation coating layer, wherein the insulation coating layer comprises an inorganic particle component and a resin component, the inorganic particle component and the resin component being in a ratio by weight percentage of 70%:30% to 90%:10%;

S2, preparing a magnetic material;

S3, integrally molding the coil and the magnetic material by compression molding, and carrying out heat treatment; and

S4, forming electrodes, which are electrically connected to two ends of the coil, outside a magnetic core formed by the magnetic material.

Further, the step S1 comprises: drawing copper wires, plating the copper wires with nickel, carrying out annealing, coating the copper wires with an insulation coating layer, coating the insulation coating layer with a self-bonding layer, carrying out baking and cooling, and winding the wires; and

Further, the step S2 comprises: granulating iron-based metal alloy soft magnetic powder, and then carrying out baking.

Further, in the step S3, the heat treatment is carried out under 180-230° C. for 2.8-3.2 h, most preferably 200° C. for 3 h.

Further, the step S4 comprises: grinding the insulation coating layer of the coil along electrode lead-out directions until the copper wires in the coil are exposed, and then forming electrodes via an electric silver plating process, preferably, forming L-shaped electrodes covering a side wall and a bottom of the magnetic core.

Compared with the conventional integrally-molded inductor, the integrally-molded inductor provided by the present invention has the following beneficial effects:

in the conventional integrally-molded inductor, an enameled wire with an organic coating such as polyurethane is adopted for the coil, and the organic coating is very easy to break during compression in the manufacturing of the integrally-molded inductor, so that the integrally-molded inductive product may be prone to have a short-circuit fault, thereby being unreliable; moreover, due to the fact that the coil cannot bear a high compression pressure, the molding density of the magnetic material integrally-molded with the coil cannot be effectively increased, so that the increase in permeability and saturation magnetic flux of the integrally-molded inductive product is influenced, and thus the performance of the inductive product is influenced. As for the integrally-molded inductor provided by the present invention, the insulation coating layer of the coil comprises a non-conductive inorganic particle component and a resin component which are uniformly mixed, the inorganic particle component and the resin component being in a ratio by weight percentage of 70%:30% to 90%:10%, and due to the non-conductive inorganic particles, the insulation coating layer not only has insulating properties, but also has excellent high-pressure resistance, so that the copper wire core is effectively protected, and the problem in the manufacturing that the conventionally used insulation coating layer for coating the copper wire core may be broken under high pressure which leads to short-circuiting of the product is overcame; besides, as the permitted compression pressure is greatly increased, the molding density of the magnetic electronic component products can be greatly increased, so that the permeability of the product is improved. By using the method for manufacturing the integrally-molded inductor disclosed by the present invention, the manufactured inductor product has good high-pressure resistance, high reliability, high permeability and good electrical properties, overcomes the defect that the electrical properties of the product are unsatisfactory due to the poor high-pressure resistance of the conventional integrally-molded inductor, and can be widely applied to the manufacturing of magnetic electronic components under high pressure.

Compared with the conventional integrally-molded inductor, the integrally-molded inductor has the following specific advantages:

### (1) High-Pressure Resistance

the compression pressure of the conventional integrally-molded inductor product is generally 500-600 MPa, and the compression pressure of the integrally-molded inductor of the present invention can reach more than 1000-1400 MPa;

### (2) High Reliability

as the highly-reliable integrally-molded inductor of the present invention adopts copper wires with an inorganic coating, the coating of the copper wires of the inductor can be effectively protected from being damaged under high pressure, so that the risks of short-circuiting of the product caused by interlayer defects that possibly exists in the conventional integrally-formed inductor are greatly reduced; and

### (3) Better Product Electrical Properties

the range of μi of the conventional integrally-molded inductor is 20-30, and as the integrally-molded inductor of the present invention has good pressure resistance, the inductor product obtained by high-pressure compression may have a higher pi which can reach 30-40.

The foregoing has outlined rather broadly the features and technical advantages of the present invention in order that the detailed description of the invention may be better understood. Specific features and advantages of the embodiments of the invention are described below.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional view of an integrally-molded inductor according to an embodiment of the present invention;

FIG. 2 is a schematic enlarged view of a region D in FIG. 1;

FIG. 3 is a schematic diagram of coil deformation during compression of an integrally-molded inductor according to an embodiment of the present invention;

FIG. 4 is a schematic enlarged view of a region E in FIG. 3; and

FIG. 5 is a schematic diagram of a process for manufacturing an integrally-molded inductor according to an embodiment of the present invention.

### DETAILED DESCRIPTION

The invention will be described below in further detail by the embodiments with reference to the accompanying drawings. It should be noted that the following description is exemplary only and is not intended to limit the scope of the invention and its application. Those skilled in the art will appreciate that the conception and specific embodiments disclosed may be readily utilized as a basis for modifying or designing other structures for the same purposes of the present invention. Those skilled in the art will also recognize that such equivalent constructions do not depart from the spirit and scope of the invention. The novel features which are believed to be characteristic of the invention, both as to its organization and method of operation, together with further objects and advantages will be better understood from the following description taken in conjunction with the accompanying drawings. It should be expressly understood, however, that each feature is provided for the purpose of illustration and description only and is not intended to limit the definition of the invention.

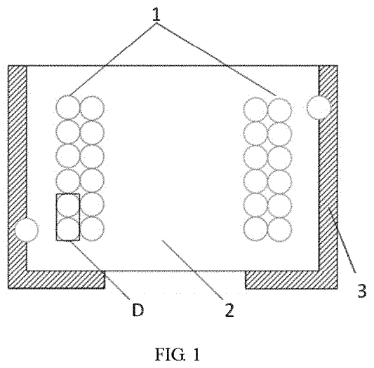

Referring to FIGS. 1 to 5, in one embodiment, an integrally-molded inductor comprises a coil 1 having an insulation coating layer 102 coating copper wires 101, and a magnetic material 2 integrally molded with the coil 1 by compression molding, with electrodes 3, which are exposed outside the magnetic material 2, formed at two ends of the coil 1, wherein the insulation coating layer 102 of the coil 1 comprises an inorganic particle component 1021 and a resin component, the inorganic particle component 1021 and the resin component being in a ratio by weight percentage of 70%:30% to 90%:10%, and the inorganic particle component 1021 is uniformly mixed with the resin component.

In a preferred embodiment, the inorganic particle component comprises any one or more of SiO₂, Al₂O₃, and SiC.

In a preferred embodiment, the resin component comprises any one or more of polyimide and polyurethane.

In a preferred embodiment, magnetic powder is iron-based metal alloy soft magnetic powder, and preferably, the soft magnetic powder is any one of carbonyl iron powder, FeSiCr, FeNi50, MPP, amorphous soft magnetic powder, and nanocrystalline soft magnetic powder, and most preferably, is FeSiCr.

In a preferred embodiment, a material for forming the electrodes 3 is silver paste. The material for forming the electrodes 3 may also be other conductive metal pastes.

In a preferred embodiment, the insulation coating layer 102 of the coil 1 is further coated with a self-bonding layer.

Referring to FIG. 5, in another embodiment, a method for manufacturing the integrally-molded inductor comprises the steps that:

S1, a coil 1 having an insulation coating layer is prepared, wherein the insulation coating layer 102 comprises an inorganic particle component 1021 and a resin component which are uniformly mixed, the inorganic particle component 1021 and the resin component being in a ratio by weight percentage of 70%:30% to 90° 5:10%;

S2, a magnetic material 2 is prepared;

S3, the coil 1 and the magnetic material 2 are integrally molded by compression molding, and heat treatment is carried out; and

S4, electrodes 3, which are electrically connected to two ends of the coil 1, are formed outside a magnetic core formed by the magnetic material 2.

In a preferred embodiment, the step S1 comprises: copper wires are drawn, the copper wires are plated with nickel, annealing is carried out, the copper wires are coated with an insulation coating layer, the insulation coating layer is coated with a self-bonding layer, baking and cooling are carried out, and the wire is wound; and

in a preferred embodiment, the step S2 comprises: iron-based metal alloy soft magnetic powder are granulated, and then baking is carried out.

In a preferred embodiment, in the step S3, the heat treatment is carried out under 180-230° C. for 2.8-3.2 h, most preferably 200° C. for 3 h.

In a preferred embodiment, the step S4 comprises: the insulation coating layer of the coil 1 is ground along lead-out directions of the electrodes 3 until the copper wires in the coil 1 are exposed, and then the electrodes 3 are formed via an electric silver plating process, preferably, L-shaped electrodes 3 covering a side wall and a bottom of the magnetic core are formed.

The electrode 3 may also be formed via other processes such as PVD/copper-melting metallization, etc.

The copper wires may be made from 99.99% or more pure copper. The copper wires may be plated with nickel.

In the conventional integrally-molded inductor, an enameled wire with an organic coating such as polyurethane is adopted for the coil, and the organic coating is very easy to break during compression in the manufacturing of the integrally-molded inductor, so that the integrally-molded inductive product may be prone to have a short-circuit fault, thereby being unreliable; moreover, due to the fact that the coil cannot bear a high compression pressure, the molding density of the magnetic material integrally-molded with the coil cannot be effectively increased, so that the increase in permeability and saturation magnetic flux of the integrally-molded inductive product is influenced, and thus the performance of the inductive product is influenced. As for the integrally-molded inductor provided by the present invention, the insulation coating layer of the coil comprises an inorganic particle component and a resin component which are uniformly mixed, the inorganic particle component and the resin component being in a ratio by weight percentage of 70%:30% to 90%:10%, and due to the existence of inorganic particles, the insulation coating layer not only has insulating properties, but also has excellent high-pressure resistance, so that the copper wire core is effectively protected, and the problem in the manufacturing that the conventionally used insulation coating layer for coating the copper wire core may be broken under high pressure which leads to short-circuiting of the product is overcame; besides, as the permitted compression pressure is greatly increased, the molding density of the magnetic electronic component product can be greatly increased, so that the permeability of the product is improved. By using the method for manufacturing the integrally-molded inductor disclosed by the present invention, the manufactured inductor product has good high-pressure resistance, high reliability, high permeability and good electrical properties, overcomes the defect that the electrical properties of the product are unsatisfactory due to the poor high-pressure resistance the conventional integrally-molded inductor, and can be widely applied to the manufacturing of magnetic electronic components under high pressure.

In a specific example, as shown in FIG. 1, the inductor comprises a coil 1, electrodes 3, and a magnetic material 2 adopting metal soft magnetic powder; and FIG. 5 shows a simple process for manufacturing the integrally-molded inductor. Firstly, a coil with a specified shape and a specified number of turns is formed by winding and then put into a mold cavity, metal soft magnetic powder is added, the coil 1 and the metal soft magnetic powder are integrally molded by applying a certain pressure, then heat treatment is carried out under 200° C. for 3 h, then outer ends of the coil 1 exposing the metal soft magnetic powder are ground, and the electrodes 3 are formed via a terminal electric silver plating process, thereby finally forming a surface mounting power inductor.

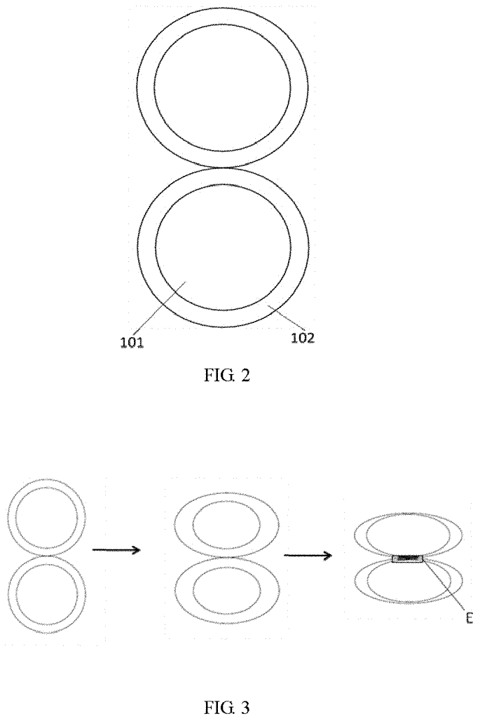

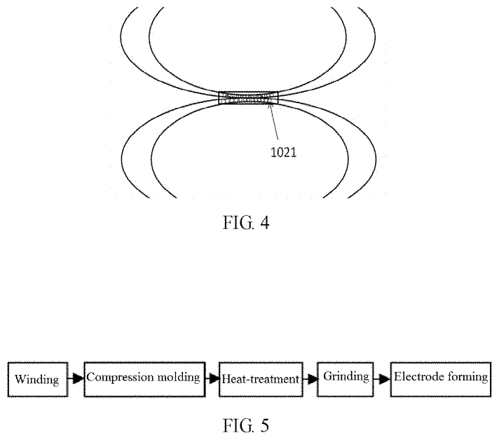

FIG. 2 is a schematic enlarged cross-sectional view of a coil according to a specific example of the present invention. The insulation coating layer outside the coil 1 is formed by mixing an inorganic particle component and an organic resin component in a weight ratio of 7:3, wherein the inorganic particle component is at least one of inorganic substances such as SiO₂, Al₂O₃, and SiC. The insulation coating layer may be coated with a self-bonding layer, which is organic resin. FIG. 3 is a schematic diagram of coil deformation during compression of a highly-reliable integrally-molded inductor according to the present invention. FIG. 4 is a schematic enlarged view of a region E in FIG. 3.

According to the integrally-molded inductor, the insulation coating layer is adopted for the coil, and due to the non-conductive inorganic particles in the insulation coating layer, force is carried by the inorganic particles and transferred to the copper wire core, and the non-conductive inorganic particles not only serve as a force transfer medium, but also serve as spacers in the insulation coating layer for isolation in the copper wire core. Therefore, during compression under high pressure, although the copper wire core deforms due to excessive pressure, with the isolation of the inorganic particle layer, the direct contact between the two copper wires and the risk of short circuiting caused thereby are prevented, and the defect of poor pressure resistance of the conventional integrally-molded inductor is overcome.

The integrally-molded inductor provided by the invention overcomes the obstacles of the conventional integrally-molded inductor that the enameled wire has a poor high-pressure resistance and a low molding density which limit the electrical properties of the product. By using the method provided by the present invention, the manufactured power inductor overcomes the conflict between molding density and pressure resistance, and has higher pressure resistance and better electrical properties.

The foregoing is a further detailed description of the present invention, taken in conjunction with specific/preferred embodiments, and is not to be construed as limiting the specific embodiments of the present invention. It will be apparent to those skilled in the art to which this invention pertains that many alternatives or modifications to the described embodiments may be devised without departing from the spirit thereof, and all such alternatives or modifications are deemed to be within the scope of this application. In the description of this specification, reference to the description of the terms “an embodiment”, “some embodiments”, “preferred embodiments”, “examples”, “specific examples”, or “some examples”, etc., means that particular features, structures, materials, or characteristics described in connection with the embodiment or example is included in at least one embodiment or example of the invention. In the present specification, schematic representations of the above terms are not necessarily directed to the same embodiments or examples. Furthermore, the particular features, structures, materials, or characteristics described may be combined in any one or more embodiments or examples in a suitable manner. Moreover, various embodiments or examples described in this specification, as well as features of various embodiments or examples, may be incorporated and combined by those skilled in the art without departing from the scope of the invention. Although embodiments of the present invention and advantages thereof have been described in detail, it should be understood that various changes, substitutions and alterations can be made herein without departing from the spirit and scope of the embodiments as defined by the appended claims. Moreover, the scope of the present invention is not intended to be limited to the particular embodiments of the processes, machines, manufacture, compositions of matter, means, methods, and steps described in the specification. Those of ordinary skill in the art will readily appreciate that the above disclosed processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrally-molded inductor, comprising a coil having an insulation coating layer and a magnetic material integrally molded with the coil by compression molding, with electrodes, which are exposed outside the magnetic material, formed at two ends of the coil, wherein the insulation coating layer of the coil comprises a non-conductive inorganic particle component and a resin component which are uniformly mixed, the inorganic particle component and the resin component being in a ratio by weight percentage of 70%:30% to 90%:10%.

2. The integrally-molded inductor according to claim 1, wherein the inorganic particle component comprises any one or more of SiO₂, Al₂O₃, and SiC.

3. The integrally-molded inductor according to claim 1, wherein the resin component comprises any one or more of polyimide and polyurethane.

4. The integrally-molded inductor according to claim 1, wherein the magnetic material is iron-based metal alloy soft magnetic powder, and preferably, the soft magnetic powder is any one of carbonyl iron powder, FeSiCr, FeNi50, MPP, amorphous soft magnetic powder, and nanocrystalline soft magnetic powder, and most preferably, is FeSiCr.

5. The integrally-molded inductor according to claim 4, wherein the soft magnetic powder is any one of carbonyl iron powder, FeSiCr, FeNi50, MPP, amorphous soft magnetic powder, and nanocrystalline soft magnetic powder.

6. The integrally-molded inductor according to claim 4, wherein the soft magnetic powder is FeSiCr.

7. The integrally-molded inductor according to claim 1, wherein a material forming the electrodes is silver paste.

8. The integrally-molded inductor according to claim 1, wherein the insulation coating layer of the coil is further coated with a self-bonding layer.

9. A method for manufacturing an integrally-molded inductor according to claim 1, comprising following steps of:
S1, preparing a coil having an insulation coating layer, wherein the insulation coating layer comprises an inorganic particle component and a resin component, the inorganic particle component and the resin component being in a ratio by weight percentage of 70%:30% to 90%:10%;
S2, preparing a magnetic material;
S3, integrally molding the coil and the magnetic material by compression molding, and carrying out heat treatment; and
S4, forming electrodes, which are electrically connected to two ends of the coil, outside a magnetic core formed by the magnetic material.

10. The method according to claim 9, wherein the step S1 comprises: drawing copper wires, plating the copper wires with nickel, carrying out annealing, coating the copper wires with an insulation coating layer, coating the insulation coating layer with a self-bonding layer, carrying out baking and cooling, and winding the wires; and
the step S2 comprises: granulating iron-based metal alloy soft magnetic powder, and then carrying out baking.

11. The method according to claim 9, wherein in the step S3, the heat treatment is carried out under 180-230° C. for 2.8-3.2 h.

12. The method according to claim 11, wherein in the step S3, the heat treatment is carried out under 200° C. for 3 h.

13. The method according to claim 9, wherein the step S4 comprises: grinding the insulation coating layer of the coil along electrode lead-out directions until the copper wires in the coil are exposed, and then forming electrodes via an electric silver plating process.

14. The method according to claim 13, wherein the electrodes are L-shaped electrodes covering a side wall and a bottom of the magnetic core.
